(19) United States
(12) Patent Application Publication
(10) Pub. No.: US 2014/0108340 A1
(43) Pub. Date: Apr. 17, 2014

(54) TARGETED MEDIA CAPTURE PLATFORMS, NETWORKS, AND SOFTWARE

(71) Applicant: CAPTURE MEDIA, INC., New York, NY (US)

(72) Inventors: Jordan Edward Osher, New York, NY (US); Jayastu Bhattacharya, New York, NY (US); John David Osher, New York, NY (US)

(73) Assignee: CAPTURE MEDIA, INC., New York, NY (US)

(21) Appl. No.: 13/752,677

(22) Filed: Jan. 29, 2013

Related U.S. Application Data
(63) Continuation of application No. 13/654,287, filed on Oct. 17, 2012, now abandoned.

(51) Int. Cl. G06F 17/30

(52) U.S. Cl. CPC G06F 17/30174
USPC 707/623

(57) ABSTRACT

Platforms, networks, and software applications for targeted media capture, and methods of providing and using the same.

### CROSS-REFERENCE TO RELATED APPLICATIONS

This application claims the benefit of U.S. application Ser. No. 13/654,287, filed Oct. 17, 2012, which is hereby incorporated by reference in its entirety.

### BACKGROUND OF THE INVENTION

Currently, news organizations, media publishers, and their media managers rely on sending a helicopter or a camera crew truck to acquire media and information to support news stories. These traditional methods carry massive expense and are slow to respond.

### SUMMARY OF THE INVENTION

In contrast to the large, heavy, and cumbersome equipment of a traditional news camera crew, the high-resolution cameras of smartphones are ubiquitous and highly mobile. Leading research firms predict that by 2016 there will be 1 billion smartphone users worldwide, with 257 million of them living in the United States. However, many barriers presently prevent media publishers from tapping into user-generated content.

The media publishing industry lacks the tools to truly take advantage of the ubiquity of smartphones. Previous attempts amount to workarounds using social media platforms. Media publishers cannot request specific content from users, resulting in generally ineffective “send us your interesting photos” messages. These attempts have been met with inconsistent user response. Content is often forged or plagiarized, irrelevant, and of poor quality.

User-generated content authors are faced with middlemen and agencies that control the relationships with media and create a chokepoint that is a “black box” for users. Lack of transparency discourages frequent submissions. Moreover, contributors face fragmented and inconsistent user experiences on social networks as each media outlet crafts a new workaround.

Plainly, there is a long-felt and unmet need for a solution to allow media outlets, publishers, and brand managers to send targeted requests for media and information and receive filtered coverage of events in real-time, anywhere in the world, at anytime. There is also a dearth of tools providing a direct connection from smartphone cameras to targeted and verified media outlets empowering individuals coming across a newsworthy or special moment to capture quality media and information.

In one aspect, disclosed herein are targeted media capture platforms comprising: a processor configured to provide an enterprise application comprising: a software module for sending media requests, wherein the media requests are geotargeted to contributors; a software module for receiving and managing media submitted by contributors; a mobile processor configured to provide a contributor mobile application comprising: a software module for receiving media requests, wherein the media requests are geofiltered; a software module for submitting media in response to media requests; a software module for receiving updates on submitted media status; and a server comprising a processor configured to provide a server application comprising: a software module for syncing media requests, media submissions, media status updates, and contributor locations between an enterprise application and one or more contributor mobile applications; a software module for authenticating submitted media. In some embodiments, media comprise text, audio recordings, photographs, videos, or combinations of the same. In further embodiments, media comprise high-definition photographs or high-definition videos. In some embodiments, the enterprise application further comprises a software module for providing a map of geolocated contributors. In some embodiments, the media requests are further targeted to contributors by subject matter. In some embodiments, the enterprise application further comprises a software module for providing a gallery to view and manage submitted media. In some embodiments, the enterprise application allows download of submitted media in full resolution. In some embodiments, the enterprise application further comprises a software module for direct messaging with one or more contributors. In some embodiments, the enterprise application is a mobile application. In some embodiments, the contributor mobile application further comprises a software module for viewing media submitted by others. In some embodiments, the contributor mobile application allows unrequested media submissions. In some embodiments, the contributor mobile application further comprises a software module for sharing media to one or more social networks or media sharing sites. In some embodiments, the contributor mobile application further comprises a software module for generating an alert, notification, or alarm when a media request is received. In some embodiments, the server application authenticates media by one or more selected from the group consisting of: location, date, time, resolution, and creator. In further embodiments, the server application utilizes exchangeable image file format (EXIF) data to perform media authentication. In some embodiments, the server application syncs media status updates that include one or more selected from the group consisting of: view, download, addition to favorites, addition to album or lightbox, reply, and selection for publication.

In another aspect, disclosed herein are computer-readable storage media encoded with a computer program including instructions executable by a processor to create a targeted media capture server application comprising: a software module for maintaining a database of contributors, wherein the database comprises a current geolocation for each contributor; a software module for receiving media requests made by enterprise users, wherein each media request comprises a request geolocation; a software module for transmitting media requests to appropriate contributors based on a request geolocation and a current geolocation for each contributor; a software module for receiving media submitted by contributors in response to a media request, wherein each submitted media comprises authentication data; a software module for authenticating submitted media; and a software module for transmitting media submitted by contributors to a requesting enterprise user. In some embodiments, submitted media comprise text, audio recordings, photographs, videos, or combinations of the same. In further embodiments, submitted media comprise high-definition photographs or high-definition videos. In some embodiments, the server application further comprises a software module for providing a map of geolocated contributors. In some embodiments, the server application further comprises a software module for providing a gallery to view and manage submitted media. In some embodiments, the software module for transmitting media submitted by contributors to a requesting enterprise user transmits media in full resolution. In some embodiments, the server application further comprises a software module for direct messaging between an enterprise user and one or more contributors. In some embodiments, the software module for receiving media submitted by contributors allows unrequested media submissions. In some embodiments, the software module for transmitting media requests to appropriate contributors generates an alert, notification, or alarm for contributors when a media request is transmitted. In some embodiments, the software module for authenticating submitted media authenticates media by one or more selected from the group consisting of: location, date, time, resolution, and creator. In further embodiments, the software module for authenticating submitted media utilizes exchangeable image file format (EXIF) data to perform media authentication. In some embodiments, the server application further comprises a software module for transmitting submitted media status updates. In further embodiments, the software module for transmitting submitted media status updates notifies contributors of changes in status that include one or more selected from the group consisting of: view, download, addition to favorites, addition to album or lightbox, reply, and selection for publication. In further embodiments, the software module for transmitting submitted media status updates notifies each contributor of changes in status of media they submitted. In further embodiments, the software module for transmitting submitted media status updates notifies each contributor of changes in status of media submitted by other contributors near their geolocation.

In another aspect, disclosed herein are computer-based targeted media capture networks comprising a server processor configured at least to: maintain a database of a plurality of contributors, wherein each contributor is associated with a current geolocation; provide substantially synchronous communications between one or more enterprise users and the plurality of contributors, wherein the communications comprise media requests by the one or more enterprise users, media submissions by the plurality of contributors in response to the media requests, and updates on the status of submitted media; and authenticate submitted media based on geolocation, date, and time data; with the proviso that each communicated media request comprises a request geolocation and is geotargeted to contributors based on a current geolocation for each contributor. In some embodiments, media comprise text, audio recordings, photographs, videos, or combinations of the same. In further embodiments, media comprise high-definition photographs or high-definition videos. In some embodiments, the server processor is further configured to provide a map of geolocated contributors. In some embodiments, the server processor is further configured to provide a gallery to view and manage submitted media. In some embodiments, the server processor is further configured to allow download of submitted media in full resolution. In some embodiments, the server processor is further configured to provide direct messaging between the one or more enterprise users and the plurality of contributors. In some embodiments, the one or more enterprise users interact with the network via an enterprise application. In some embodiments, the plurality of contributors interact with the network via a contributor mobile application. In some embodiments, the authentication utilizes exchangeable image file format (EXIF) data to perform media authentication. In some embodiments, the updates on the status of submitted media include one or more selected from the group consisting of: view, download, addition to favorites, addition to album or lightbox, reply, and selection for publication.

In another aspect, disclosed herein are methods comprising the steps of: monitoring the geolocation of a population of contributors, wherein each contributor is a user of a dedicated mobile application in communication with a targeted media capture server; transmitting, via the targeted media capture server, a media request, wherein the media request is geotargeted to a subpopulation of contributors based on a current geolocation for each contributor; and receiving, via the targeted media capture server, authenticated media submitted in response to the media request, wherein the media comprises at least one photograph, at least one video, or at least one photograph and at least one video. In some embodiments, media comprise text, at least one audio recording, or text and at least one audio recording. In further embodiments, media comprise at least one high-definition photograph, at least one high-definition video, or at least one high-definition photograph and at least one high-definition video. In some embodiments, media is authenticated at the targeted media capture server utilizing one or more selected from the group consisting of: location, date, time, resolution, and creator. In further embodiments, media is authenticated at the targeted media capture server utilizing exchangeable image file format (EXIF) data to perform media authentication. In some embodiments, the method further comprises the step of sending a direct message, via the targeted media capture server, to a contributor in response to receiving authenticated media submitted by the contributor.

In another aspect, disclosed herein are methods comprising the steps of: providing an enterprise application comprising: a software module for sending media requests, wherein the media requests are geotargeted to contributors; a software module for receiving and managing media submitted by contributors; providing a contributor mobile application comprising: a software module for receiving media requests, wherein the media requests are geofiltered; a software module for submitting media in response to media requests; a software module for receiving updates on submitted media status; and providing a server application comprising: a software module for syncing media requests, media submissions, media status updates, and contributor locations between an enterprise application and one or more contributor mobile applications; a software module for authenticating submitted media. In some embodiments, media comprise text, audio recordings, photographs, videos, or combinations of the same. In further embodiments, media comprise high-definition photographs or high-definition videos. In some embodiments, the enterprise application further comprises a software module for providing a map of contributor locations. In some embodiments, the media requests are further targeted to contributors by subject matter. In some embodiments, the enterprise application further comprises a software module for providing a gallery to view and manage submitted media. In some embodiments, the enterprise application allows download of submitted media in full resolution. In some embodiments, the enterprise application further comprises a software module for direct messaging with one or more contributors. In some embodiments, the contributor mobile application further comprises a software module for viewing media submitted by others. In some embodiments, the contributor mobile application allows unrequested media submissions. In some embodiments, the contributor mobile application further comprises a software module for sharing media to one or more social networks or media sharing sites. In some embodiments, the contributor mobile application further comprises a software module for generating an alert, notification, or alarm when a media request is received. In some embodiments, the server application authenticates media by one or more selected from the group consisting of: location, date, time, and creator. In further embodiments, the server application utilizes exchangeable image file format (EXIF) data to perform media authentication. In some embodiments, the server application syncs media status updates that include one or more selected from the group consisting of: view, download, addition to favorites, addition to album or lightbox, reply, and selection for publication.

### BRIEF DESCRIPTION OF THE DRAWINGS

FIG. 1 shows a non-limiting example of a GUI for an enterprise application; in this case, an interface for creating a targeted media request where an enterprise user optionally selects a request location on a map.

FIG. 2 shows a non-limiting example of a GUI for an enterprise application; in this case, an interface for previewing a media request as it would appear on a contributor mobile application.

FIG. 3 shows a non-limiting example of a GUI for an enterprise application; in this case, an interface for viewing details for a media request including thumbnails representing media submitted in response to the request.

FIG. 4 shows a non-limiting example of a GUI for an enterprise application; in this case, an interface for viewing details of submitted media including authentication information, such as, contributor, location, and dates and times of capture and submission.

FIG. 5 shows a non-limiting example of a GUI for an enterprise application; in this case, an interface for viewing enterprise user notifications.

FIG. 6 shows a non-limiting example of a GUI for a contributor mobile application; in this case, an interface including a list of media requests, each request including the requesting media outlet, a title a location, and a deadline for submission of captured media in response to the request.

FIG. 7 shows another non-limiting example of a GUI for a contributor mobile application; in this case, an interface for providing details for an individual media request including an element to capture media in response to the request.

FIG. 8 shows another non-limiting example of a GUI for a contributor mobile application; in this case, an interface for using the camera of a mobile device to capture one or more photos or videos in response to a media request.

FIG. 9 shows a non-limiting example of a GUI for a contributor mobile application; in this case, an interface including elements to add text and/or voice notes to captured media and to view a location for captured media.

FIG. 10 shows a non-limiting example of a GUI for a contributor mobile application; in this case, an interface for typing text notes (e.g., comments, annotations, etc.) associated with captured media.

FIG. 11 shows a non-limiting example of a GUI for a contributor mobile application; in this case, an interface for recording audio notes (e.g., comments, annotations, etc.) associated with captured media.

FIG. 12 shows another non-limiting example of a GUI for a contributor mobile application; in this case, an interface for previewing captured media prior to submission to a requesting media outlet.

FIG. 13 shows another non-limiting example of a GUI for a contributor mobile application; in this case, an interface for previewing captured media that includes the location where the media was captured.

FIG. 14 shows another non-limiting example of a GUI for a contributor mobile application; in this case, an interface including thumbnails that represent media captured by a contributor.

FIG. 15 shows another non-limiting example of a GUI for a contributor mobile application; in this case, an interface for providing notifications regarding the status of media submitted by a contributor. In some embodiments, status includes, by way of non-limiting examples, submission, views, downloads, and exclusive downloads. In further embodiments, notifications include new requests for media (e.g., assignments).

FIG. 16 shows another non-limiting example of a GUI for a contributor mobile application; in this case, an interface for direct messaging between a contributor and a media outlet regarding submitted media.

### DETAILED DESCRIPTION OF THE INVENTION

Traditional methods for media outlets to acquire media assets require large, heavy, and cumbersome equipment used by news camera crews. These prior technologies fail to leverage the ubiquitous and portable high-resolution cameras of smartphones. Media publishers have focused on using social media to reach out to contributors. However, these efforts have not amounted to more than ineffective “send us your interesting photos” messages. Moreover, the result is content that is often forged or plagiarized, irrelevant, and of poor quality. Additionally, under the current regime, content contributors are faced with middlemen and agencies that control the relationships with media, hamper transparency, and discourage frequent submissions.

Advantages of the systems, platforms, software, networks, and methods described herein include, but are not limited to, allowing media outlets, publishers, and brand managers to send targeted requests for media and information and receive filtered coverage of events in real-time, anywhere in the world, at anytime. The systems, platforms, software, networks, and methods described herein also offer the advantage of providing media contributors with total visibility into how their submissions are viewed, handled, and selected for publication.

Described herein, in various embodiments, are targeted media capture platforms comprising: a processor configured to provide an enterprise application comprising: a software module for sending media requests, wherein the media requests are geotargeted to contributors; a software module for receiving and managing media submitted by contributors; a mobile processor configured to provide a contributor mobile application comprising: a software module for receiving media requests, wherein the media requests are geofiltered; a software module for submitting media in response to media requests; a software module for receiving updates on submitted media status; and a server comprising a processor configured to provide a server application comprising: a software module for syncing media requests, media submissions, media status updates, and contributor locations between an enterprise application and one or more contributor mobile applications; a software module for authenticating submitted media.

Also described herein, in various embodiments, are computer-readable storage media encoded with a computer program including instructions executable by a processor to create a targeted media capture server application comprising: a software module for maintaining a database of contributors, wherein the database comprises a current geolocation for each contributor; a software module for receiving media requests made by enterprise users, wherein each media request comprises a request geolocation; a software module for transmitting media requests to appropriate contributors based on a request geolocation and a current geolocation for each contributor; a software module for receiving media submitted by contributors in response to a media request, wherein each submitted media comprises authentication data; a software module for authenticating submitted media; and a software module for transmitting media submitted by contributors to a requesting enterprise user.

Also described herein, in various embodiments, are computer-based targeted media capture networks comprising a server processor configured at least to: maintain a database of a plurality of contributors, wherein each contributor is associated with a current geolocation; provide substantially synchronous communications between one or more enterprise users and the plurality of contributors, wherein the communications comprise media requests by the one or more enterprise users, media submissions by the plurality of contributors in response to the media requests, and updates on the status of submitted media; and authenticate submitted media based on geolocation, date, and time data; with the proviso that each communicated media request comprises a request geolocation and is geotargeted to contributors based on a current geolocation for each contributor.

Also described herein, in various embodiments, are methods comprising the steps of: monitoring the geolocation of a population of contributors, wherein each contributor is a user of a dedicated mobile application in communication with a targeted media capture server; transmitting, via the targeted media capture server, a media request, wherein the media request is geotargeted to a subpopulation of contributors based on a current geolocation for each contributor; and receiving, via the targeted media capture server, authenticated media submitted in response to the media request, wherein the media comprises at least one photograph, at least one video, or at least one photograph and at least one video.

Also described herein, in various embodiments, are methods comprising the steps of: providing an enterprise application comprising: a software module for sending media requests, wherein the media requests are geotargeted to contributors; a software module for receiving and managing media submitted by contributors; providing a contributor mobile application comprising: a software module for receiving media requests, wherein the media requests are geofiltered; a software module for submitting media in response to media requests; a software module for receiving updates on submitted media status; and providing a server application comprising: a software module for syncing media requests, media submissions, media status updates, and contributor locations between an enterprise application and one or more contributor mobile applications; a software module for authenticating submitted media.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Contributors

In some embodiments, the systems, platforms, software, networks, and methods described herein include a software module for creating and/or maintaining a database of contributors and/or contributor-related information, or use of the same. In some embodiments, as used herein, a “contributor” is any individual, group, or entity operating a contributor application as described herein. In further embodiments, a contributor potentially receives one or more media requests and/or optionally submits one or more media files. In some embodiments, a database of contributors includes a wide range of information associated with each contributor. By way of non-limiting examples, a database of contributors includes, name, credentials, professional affiliation, media requests received, media submissions made, views and downloads of submitted media, replies to submitted media, views of media submitted by others associated with each contributor. In some embodiments, a database of contributors includes a geolocation (e.g., last reported location, current location, etc.) associated with each contributor. In some embodiments, a database of contributors includes a one or more subject matters associated with each contributor. In further embodiments, a contributor is associated with one or more subject matter topics in which they have interest, knowledge, experience, and/or expertise.

In view of the disclosure provided herein, those of skill in the art will recognize that many databases are suitable for storage and retrieval of contributor information, including contributor geolocation information. In various embodiments, suitable databases include, by way of non-limiting examples, relational databases, non-relational databases, object oriented databases, object databases, entity-relationship model databases, associative databases, and XML databases. In some embodiments, a database of contributors in a computer memory is internet-based. In further embodiments, a database of contributors in a computer memory is web-based. In still further embodiments, a database of contributors in a computer memory is cloud computing-based. In other embodiments, a database of contributors in a computer memory is based on one or more local computer storage devices.

### Geolocation

In some embodiments, the systems, platforms, software, networks, and methods described herein include a software module for creating and/or maintaining a database of contributors including a geolocation for each contributor, or use of the same. In further embodiments, the geolocation is a current geolocation provided by a contributor application. In still further embodiments, the systems, platforms, software, networks, and methods described herein also include a software module for providing a map of geolocated contributors. In some embodiments, the systems, platforms, software, networks, and methods described herein include software modules for creating media requests and transmitting media requests to contributors. In further embodiments, media requests comprise a request geolocation. In some embodiments, the systems, platforms, software, networks, and methods described herein include a software module for receiving media requests. In further embodiments, media requests comprise a request geolocation. In further embodiments, media requests are geotargeted to specific contributors based on a request geolocation and a current geolocation for each contributor.

Geolocation is the identification of the real-world geographic location of an object, such as a mobile smartphone or an Internet-connected computer. A location is suitably expressed in a number of ways including, by way of non-limiting examples, geographic coordinates (e.g., latitude and longitude), a place name (e.g., county, city, landmark, intersection, etc.), a physical street address, distance from a given location, presence within a specified radius from a given location, and a graphical depiction on a map. In some cases, geolocation involves geocoding to find associated latitude and longitude from other geographic data. In some cases, geolocation involves reverse geocoding to back code latitude and longitude coordinates to a readable address or place name.

Many methods of geolocation are suitable that utilize several underlying sources of location information. In some embodiments, a software module geolocates, for example, a news event or a contributor using sources of location information including, by way of non-limiting examples, GPS coordinates provided by a processing device, triangulation between mobile phone towers and public masts (e.g., assistive GPS), Wi-Fi connection location, WHOIS performed on IP address or MAC address, GSM/CDMA cell IDs, and location information self-reported by a user. In some embodiments, location information includes position (e.g., latitude and longitude), elevation, heading, speed, orientation, and combinations thereof.

In some embodiments, a software module geolocates, for example, a news event or a contributor using the HTML 5 geolocation API. In light of the disclosure provided herein, those of skill in the art will recognize that the HTML 5 geolocation API is supported in Internet Explorer 9.0+, Firefox 3.5+, Safari 5.0+, Chrome 5.0+, Opera 10.6+, iOS 3.0+, Android 2.0+, and Windows Phone 7.5+. In some embodiments, a software module geolocates, for example, a news event or a contributor using methods aligned with W3C Geolocation API (available at: http://dev.w3.org/geo/api/spec-source.html). The W3C Geolocation API defines an interface to location information associated with a processing device (e.g., smartphone, tablet computer, laptop computer, etc.) hosting the implementation, such as latitude and longitude.

In some embodiments, the systems, platforms, software, networks, and methods disclosed herein perform geolocation by one method, such as those disclosed herein. In other embodiments, the systems, platforms, software, networks, and methods disclosed herein perform geolocation by more than one method.

In some embodiments, the geolocation of, for example, a news event or a contributor is accurate to within at least 100, 90, 80, 70, 60, 50, 40, 30, 20, 10, 9, 8, 7, 6, 5, 4, 3, 2, 1 or fewer kilometers, including increments therein. In further embodiments, the geolocation is accurate to within at least 1000, 900, 800, 700, 600, 500, 400, 300, 200, 100, 90, 80, 70, 60, 50, 40, 30, 20, 10, 9, 8, 7, 6, 5, 4, 3, 2, 1 or fewer meters, including increments therein. In some embodiments, the geolocation of a contributor is updated in the database, for example, once a day, once an hour, once a minute, or once a second, including increments therein. In further embodiments, the geolocation of a contributor is updated in the database on a continuous or substantially continuous basis to provide real-time or substantially real-time location information.

In some embodiments, media requests are geotargeted to one or more contributors based on a location identified in the media request and a current geolocation for each contributor. Accordingly, in some embodiments, the systems, platforms, software, networks, and methods described herein include a software module for determining the distance between one or more contributors and a specified location, such as the location of a news event. In further embodiments, a software module for determining the distance between one or more contributors and a specified location identifies contributors within a specified radius from a specified location.

### Media

In some embodiments, the systems, platforms, software, networks, and methods described herein include software modules for creating, transmitting, and receiving targeted media requests, or use of the same. In some embodiments, the systems, platforms, software, networks, and methods described herein include a software module for transmitting media submitted in response to a media request, or use of the same.

Many types of media are suitable. In some embodiments, suitable media include text, documents, e-books, audio, images (e.g., photographs, illustrations, etc.), videos, multimedia (e.g., interactive elements, games, etc.), or combinations of the same.

Many text formats are suitable including, by way of non-limiting examples, Rich Text Format (RTF), TXT, ASCII, UTF-8, and HTML formatted text. Many document formats are suitable including, by way of non-limiting examples, Microsoft® Office Word®, Microsoft® Office PowerPoint®, Microsoft® Office Excel®, DocBook, HTML, OpenDocument, PalmDoc, Portable Document Format (PDF), Rich Text Format (RTF), and WordPerfect.

Many e-book formats are suitable including, by way of non-limiting examples, plain text, hypertext markup language (HTML), Amazon® Kindle™, Open Electronic Package, TomeRaider, Arghos Diffusion, Flip Books, ANSI/NISO Z39.86 (DAISY), FictionBook, Text Encoding Initiative, Plucker, Compressed HM, Portable Document Format, PostScript, DjVu, Microsoft LIT, eReader, Desktop Author, Newton eBook, Founder Electronics, Libris, Mobipocket, EPUB, Broadband eBooks (BBeB), SSReader, TealDoc, IEC 62448, and Comic Book Archive file. Suitable e-books include those formatted for viewing on, by way of non-limiting examples, Apple® iPad®, Amazon®Kindle™, Barnes & Noble Nook™, Sony Reader™, iRex iLiad, the Jinke Hanlin eReader, Bookeen CyBook, Endless Ideas BeBook, and the Kobo™ eReader.

Many audio formats are suitable including, by way of non-limiting examples, MP3, WAV, AIFF, AU, Apple® Lossless, MPEG-4, Windows Media®, Vorbis, AAC, and Real Audio®.

Many raster image formats are suitable including, by way of non-limiting examples, Joint Photographic Experts Group (JPEG), JPEG 2000, Exchangeable image file format (EXIF), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), wireless bitmap (WBMP), and WebP. In some embodiments, images are uncompressed (e.g., RAW format). In other embodiments, images are compressed. Both lossy and lossless image CODECs are suitable. Many vector image formats are suitable including, by way of non-limiting examples, CGM and SWF. Both two-dimensional and three-dimensional vector images are suitable.

Many video formats are suitable including, by way of non-limiting examples, Windows® Media Video (WMV), Windows® Media®, Motion Picture Experts Group (MPEG), Audio Video Interleave (AVI), Apple® QuickTime®, RealMedia®, Flash Video, Motion JPEG (M-JPEG), WebM, and Advanced Video Coding High Definition (AVCHD). In some embodiments, video is uncompressed (e.g., RAW format). In other embodiments, video is compressed. Both lossy and lossless video CODECs are suitable including, by way of non-limiting examples, DivX™, Cineform, Cinepak, Dirac, DV, FFV1, H.263, H.264, H.264 lossless, JPEG 2000, MPEG-1, MPEG-2, MPEG-4, On2 Technologies (VP5, VP6, VP7, and VP8), RealVideo, Snow lossless, Sorenson Video, Theora, and Windows Media Video (WMV).

In some embodiments, image and/or video media are standard-definition. In other embodiments, image and/or video media are high-definition. In further embodiments, a high-definition image or video frame includes at least about 1280× about 720 pixels or at least about 1920× about 1080 pixels.

Many multimedia formats are suitable including, by way of non-limiting examples, Adobe® Flash®, Apple® QuickTime®, Microsoft® Silverlight®, Java™, HTML 5, XHTML 5, and Unity®.

In some embodiments, media include authentication information. In further embodiments, authentication information describes the location, date, time, resolution, and/or creator of the media. In still further embodiments, authentication information describes the device settings (e.g., camera, smartphone, handheld computing device, etc.) used to capture the media. In still further embodiments, authentication information describes the copyright information for the media. Authentication information is suitably associated with media in a variety of ways. In some embodiments, authentication information is incorporated in a file name or a directory associated with media. In some embodiments, authentication information is a watermark or soundmark associated with media. In some embodiments, authentication information is metadata associated with media. In some embodiments, authentication information is embedded within the media file itself.

In some embodiments, authentication information is EXIF data associated with media. In further embodiments, authentication information is EXIF data embedded within the media file. EXIF is a standard that specifies the formats for images, sound, and ancillary tags used by digital cameras (including smartphones), scanners and other systems handling image and sound files recorded by digital cameras.

In some embodiments, authentication information is associated with media by the author, creator, or contributor at the time it is captured. In other embodiments, authentication information is associated with media by the author, creator, or contributor at the time it is submitted. In some embodiments, authentication information is automatically associated with media by the media capture device at the time the media is captured. In other embodiments, authentication information is automatically associated with media by the server application at the time the media is submitted.

### Media Outlets

In some embodiments, the systems, platforms, software, networks, and methods described herein include enterprise users who interact with targeted media capture network via an enterprise application. In further embodiments, enterprise users optionally request geotargeted media, view, organize, and manage submitted media, and communicate with media contributors via an enterprise application. In further embodiments, enterprise users are associated with one or more media outlets.

Many types of media outlets have a need for media submitted in response to requests targeted by location and/or subject matter to specific contributors. Accordingly, individuals, groups, organizations, or entities associated with a wide range of media outlets are suitable enterprise users.

In some embodiments, suitable media outlets include mass media organizations specializing in communications via, by way of non-limiting examples, broadcast, film, video games, audio recording and reproduction, Internet, blog, RSS feed, podcast, SMS, mobile applications, social networks, print media, books, magazine, newspaper, outdoor media, and the like. In further embodiments, suitable media outlets include, by way of non-limiting examples, producers and publishers of print media such as newspapers, magazines, periodicals, newsletters, and the like. In further embodiments, suitable media outlets include, by way of non-limiting examples, producers and publishers of electronic media such as films, television, cable, and satellite channels, shows, and news agencies, blogs, website, podcasts, Internet radio stations, Internet television shows, video games, social media, and the like.

By way of further non-limiting examples, suitable media outlets include governments, groups, entities, and individuals wishing to quickly gather and disseminate original media content. In some embodiments, media outlets include emergency response agencies and organizations.

### Enterprise Application

In some embodiments, the systems, platforms, software, networks, and methods described herein include an enterprise application. In further embodiments, an enterprise application is adapted for use by enterprise users associated with media outlets. In further embodiments, an enterprise application includes tools and elements to enable enterprise users associated with media outlets to create and send media requests to contributors based on location and/or subject matter. In still further embodiments, an enterprise application includes tools and elements to enable enterprise users associated with media outlets to receive, view, and optionally download media submitted by contributors.

In some embodiments, an enterprise application includes a software module for creating and sending media requests. In further embodiments, media requests are geotargeted to particular contributors. In other embodiments, media requests are not targeted, but sent to the general population of contributors. In some embodiments, an enterprise application includes a software module for providing a map of indicating the location of contributors.

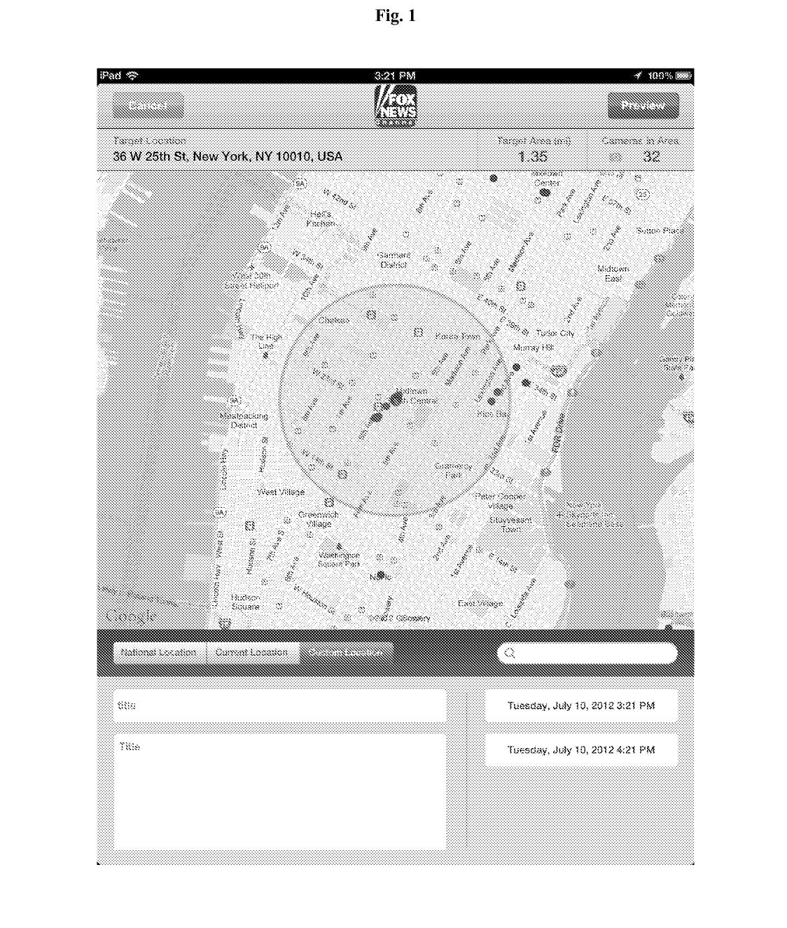

Referring to FIG. 1, in a particular embodiment, a software module for creating and sending media requests includes an interface for creating targeted media requests. Further in this embodiment, an enterprise user optionally selects a request location on a map, where the map displays the location of each contributor present. Still further in this embodiment, an enterprise user optionally selects a radius around the request location to identify contributors targeted to receive the media request. In this embodiment, an enterprise user has specified the location of 36 W 25^{th} Street, New York, N.Y., 10010 in the United States. The user has further specified a radius of 1.35 miles. The location and radius define an area in which 32 contributors are present.

In various embodiments, an enterprise user specifies a request location by, for example, typing an address, speaking an address, or indicating (e.g., touching, taping, clicking, etc.) a location on a map. Many radius distances are suitable and are suitably described in a variety of units. In various embodiments, suitable radii include, by way of non-limiting examples, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100 or more miles, including increments therein. In further various embodiments, suitable radii include, by way of non-limiting examples, 100, 200, 300, 400, 500, 600, 700, 800, 900, 1000 or more miles, including increments therein. In other embodiments radii are described in feet, yards, meters, kilometers, and the like. In yet other embodiments request locations are specified by landmark, street, route, city, county, state, region, country, or the like.

In some embodiments, media requests are targeted to particular contributors based on the subject matter of the requested media. In further embodiments, media requests are targeted to particular contributors based on the type of media requested, for example, text, audio, photograph, or video. In further embodiments, media requests are targeted to particular contributors based on the nature of the subject matter, for example, a person, a sporting event, an entertainment event, a political event, an area affected by an event, a natural disaster, a crime, or the like.

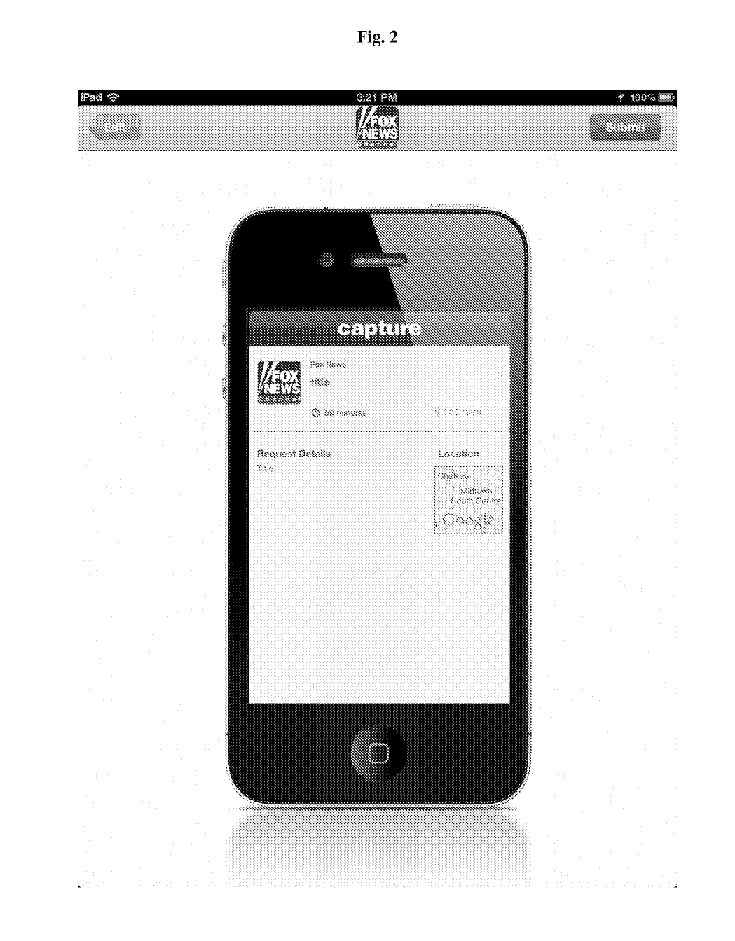

Referring to FIG. 2, in a particular embodiment, a software module for creating and sending media requests includes an interface for previewing a media request as it would appear on a contributor mobile application. In this embodiment, an exemplary media request includes the name and logo of the requesting media outlet, a title, a location (including a thumbnail of a map indicating the location), and details of the request. Further in this embodiment, a media request includes the length of time since the request was made and the contributor's current distance from the request location. In this particular embodiment, an interface for previewing a media request as it would appear on a contributor mobile application includes GUI elements for an enterprise user to edit the previewed request or to submit the request to targeted contributors.

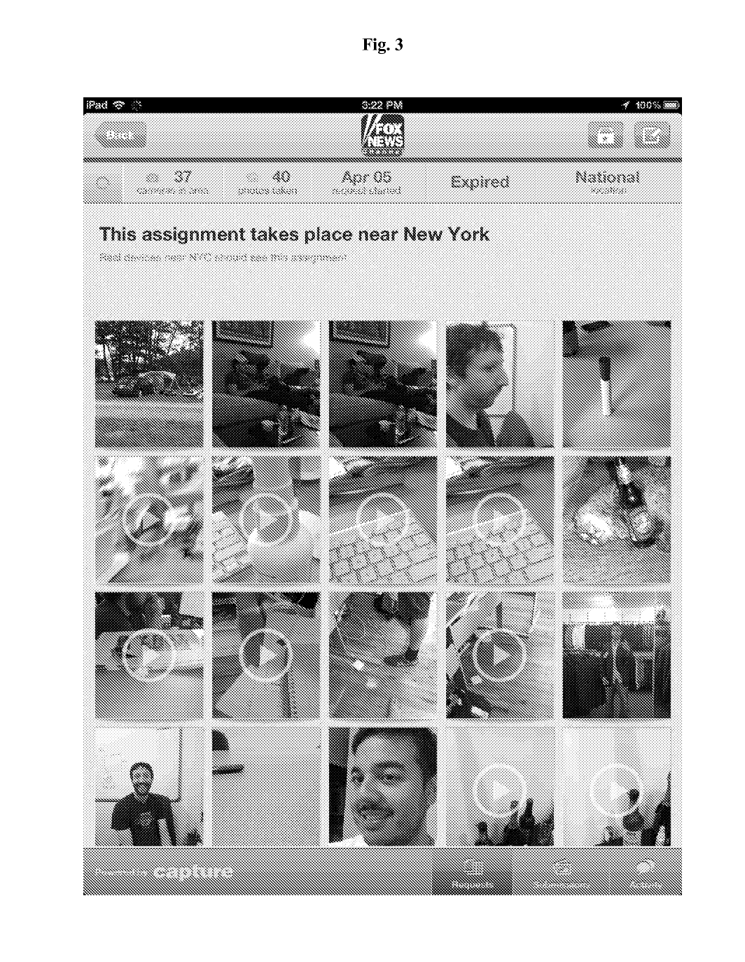

Referring to FIG. 3, in a particular embodiment, an enterprise application includes an interface for receiving and managing media submitted by contributors. In this embodiment, enterprise users view a gallery of thumbnail images representing media submitted in response to a media request. Further in this embodiment, an interface for receiving and managing media submitted by contributors includes information about the request including the title, location, date the request was sent, number of media submitted, and the number of contributors currently within the designated area.

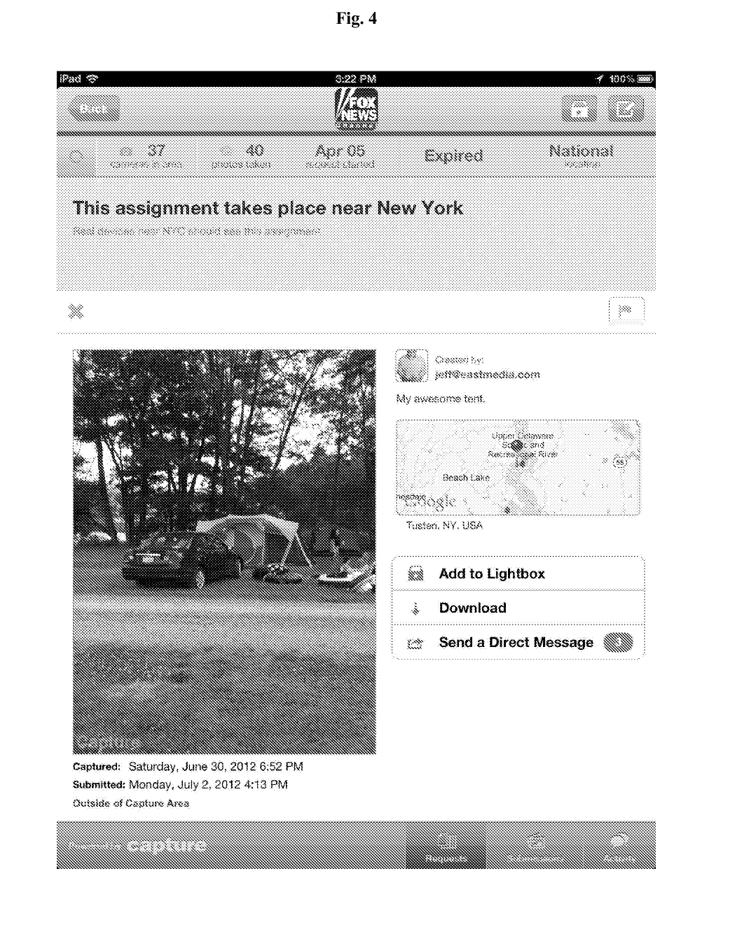

Referring to FIG. 4, in a particular embodiment, an enterprise application includes a software module for viewing details of submitted media. In this embodiment, an software module for viewing details of submitted media provides an interface that includes media authentication information, such as, contributor, location where the media was captured (including a map), and date and time of media capture and submission. Also in this embodiment, an interface for viewing details of submitted media includes comments, notes, and/or annotations made by the contributor as well as contributor contact information (e.g., email address, phone number, etc.). Further in this embodiment, an interface for viewing details of submitted media includes information about the media request including the title, location, date the request was sent, number of media submitted, and the number of contributors currently within the designated area.

In some embodiments, an enterprise application includes a software module for viewing details of submitted media that provides tools for an enterprise user to utilize the submitted media. In further embodiments, an enterprise application provides tools for an enterprise user to, for example, download of submitted media in full resolution, add submitted media to a list of favorites, and/or add submitted media to a lightbox. Again, referring to FIG. 4, in a particular embodiment, an enterprise application includes a software module for viewing details of submitted media that provides tools for an enterprise user to download the media and add the submitted media to a lightbox.

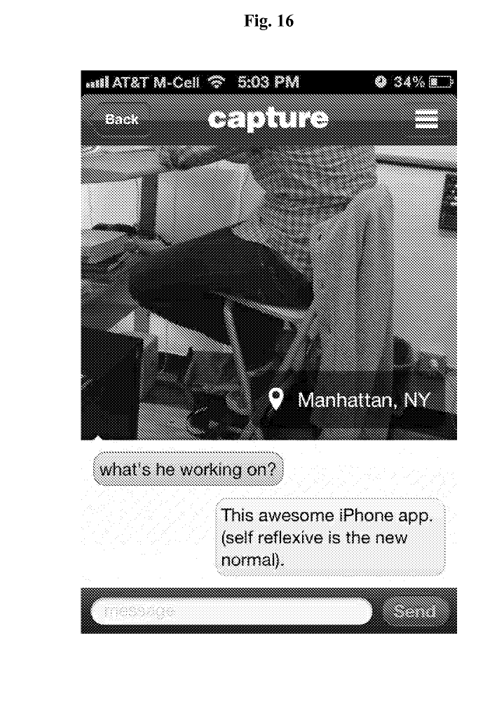

In some embodiments, an enterprise application includes a software module for direct messaging between an enterprise user and one or more contributors. In further embodiments, direct messaging allows an enterprise user to, for example, request additional authentication information for submitted media, request additional media submissions, and/or discuss the details of submitted media with the contributor. Again, referring to FIG. 4, in a particular embodiment, an enterprise application includes tools to allow an enterprise user to send a direct message to a contributor regarding submitted media. See also FIG. 16.

In some embodiments, an enterprise application includes a software module that provides an interface for viewing enterprise user notifications. In various embodiments, notifications suitable for an enterprise user include, by way of non-limited examples, direct messages from contributors, creation of new media requests, creation of new lightboxes for submitted media, views of submitted media, downloads of submitted media, and the like. In some embodiments, enterprise user notifications alert the user to events occurring within the media outlet that the user is associated with. In other embodiments, enterprise user notifications alert the user to events occurring within and outside the media outlet that the user is associated with.

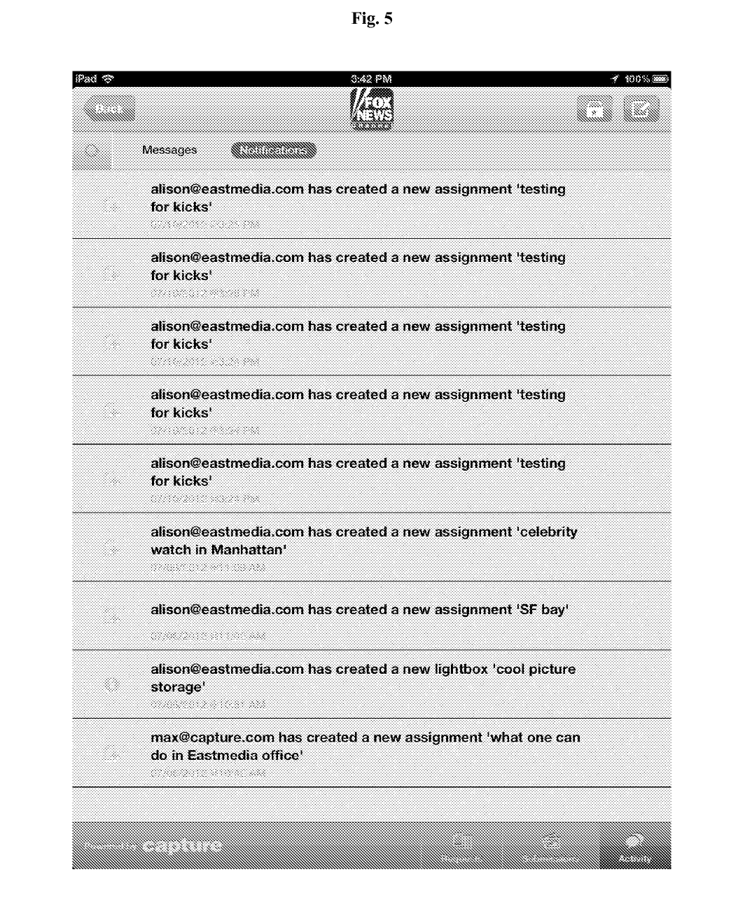

Referring to FIG. 5, in a particular embodiment, an enterprise application includes an interface for viewing enterprise user notifications. In this embodiment, an interface for viewing enterprise user notifications includes direct messages from contributors. Further in this embodiment, enterprise user notifications include notifications of new media requests and new lightboxes being created by others within the same media outlet.

In some embodiments, an enterprise application is a standalone application installed by enterprise users on a computing device such as a desktop or laptop computer. In some embodiments, an enterprise application is a web application available on the world wide web and accessible to enterprise users via a web browser. In other embodiments, an enterprise application is a mobile application installed by enterprise users on a mobile computing device such as a smartphone or tablet computer.

### Contributor Application

In some embodiments, the systems, platforms, software, networks, and methods described herein include a contributor application. In further embodiments, a contributor application is adapted for use by contributors. In further embodiments, a contributor application includes tools and elements to enable contributors to receive media requests from enterprise users, capture media, and submit captured media in response to media requests. In still further embodiments, a contributor application includes tools and elements to enable contributors to submit media that is not in response to a specific media request.

In some embodiments, a contributor application includes a software module for receiving media requests. In some embodiments, the media requests are geofiltered. In still further embodiments, contributors receive requests based on their current location (e.g., their presence within an area defined by the requestor). In some embodiments, the media requests are filtered by the subject matter of the media requested and/or the type of media requested. In still further embodiments, contributors receive requests based on their personal knowledge, skills, experience, or access to individuals, places, events, and the like.

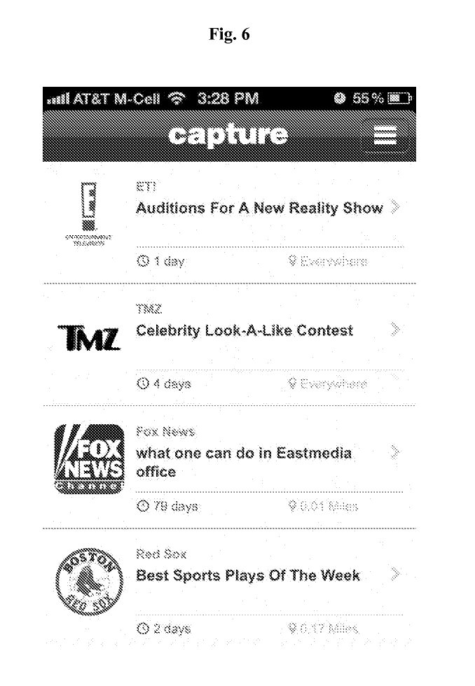

Referring to FIG. 6, in a particular embodiment, a software module for receiving media requests includes a list of media requests received. In this embodiment, each request includes the requesting media outlet, a title a location, and a deadline for submission of captured media in response to the request. Further in this embodiment, a list of media requests received includes an element to access details for each request.

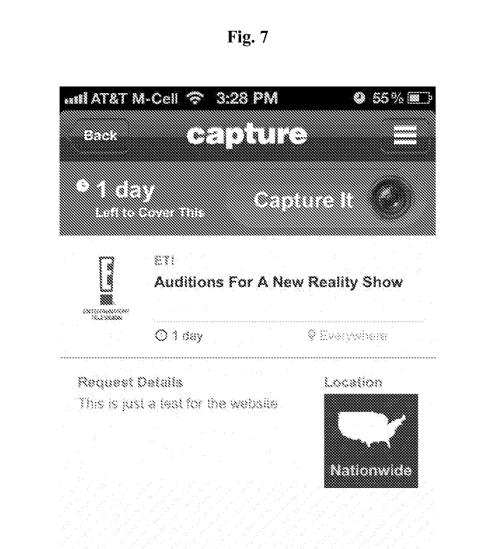

Referring to FIG. 7, in a particular embodiment, a software module for receiving media requests includes an interface for providing details for an individual media request. In this embodiment, details for a media request include the requesting media outlet, the title, a description of the request, the location and a deadline in which to submit captured media in response to the request. Further in this embodiment, the interface includes an element to capture media in response to the request.

In some embodiments, a contributor application includes a software module for capturing and submitting media. In further embodiments, media is captured and submitted in response to a media request. In other embodiments, media is captured and submitted unsolicited and not in response to any particular media request. In some embodiments, a software module for capturing and submitting media interacts with a computing device to activate and/or utilize integrated or connected media capture components including, by way of non-limiting examples, a digital still camera, a digital video camera, an audio recording devices, and the like.

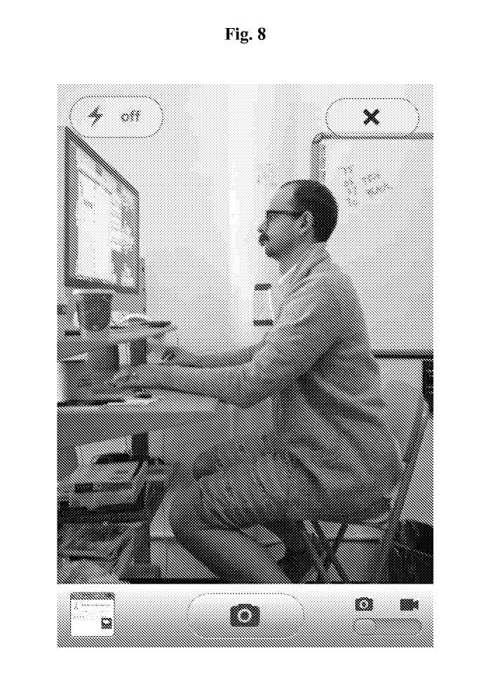

Referring to FIG. 8, in a particular embodiment, a software module for capturing and submitting media provides an interface for using the camera of a mobile device to capture one or more photos or videos in response to a media request. In this embodiment, an interface for using the camera of a mobile device includes an element to switch between still and video formats, an element to toggle on and off the flash feature of the device, and an element to capture the media.

In some embodiments, a contributor application includes a software module for allowing a contributor to describe, comment on, and/or annotate captured media. In further embodiments, contributor descriptions, comments, annotations, and/or notes provide details and context that may not be apparent from the request or media themselves. Many formats are suitable for descriptions, comments, annotations, and/or notes. In various embodiments, suitable formats include, by way of non-limiting examples, text, audio, maps, and images. In further embodiments, audio includes, by way of non-limiting examples, a recording of the voice of the contributor, a recording of an interview, and/or a recording of the ambient sounds of an environment, scene, or event.

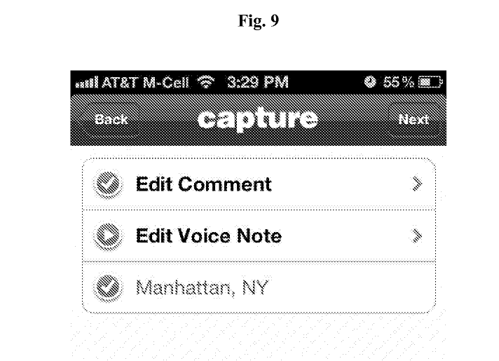

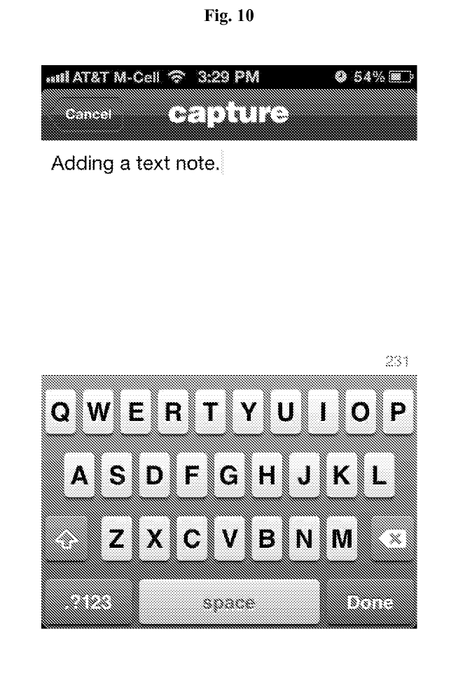

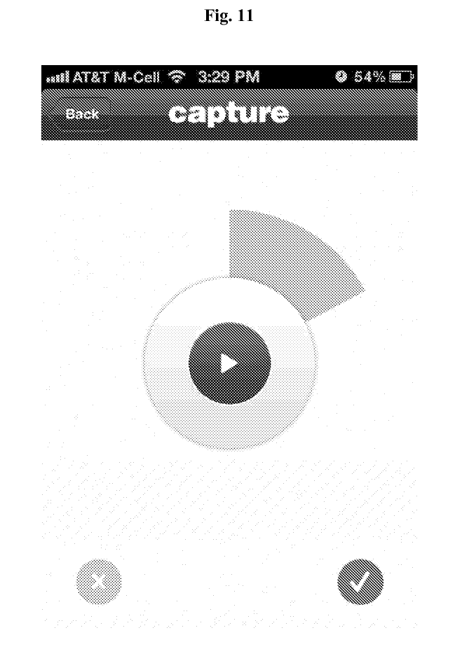

Referring to FIG. 9, in a particular embodiment, a software module for allowing a contributor to describe, comment on, and/or annotate captured media includes an interface for adding text and/or voice notes to captured media and to view a location for captured media. See also, FIGS. 10, 11.

Referring to FIG. 10, in a particular embodiment, a software module for allowing a contributor to describe, comment on, and/or annotate captured media includes an interface for typing text associated with captured media.

Referring to FIG. 11, in a particular embodiment, a software module for allowing a contributor to describe, comment on, and/or annotate captured media includes an interface for recording audio associated with captured media. In this embodiment, the interface includes elements to record, play, save, and delete recorded audio.

In some embodiments, a contributor application includes a software module for allowing a contributor to preview captured media prior to submission. In further embodiments, a software module for allowing a contributor to preview captured media prior to submission provides an interface for previewing captured photographs and/or videos and any descriptions, comments, annotations, and/or notes added by the contributor, including those in text, image, and/or audio formats. In still further embodiments, an interface for previewing captured media displays authentication information for the media such as location, date and time of capture, contributor information, and the like.

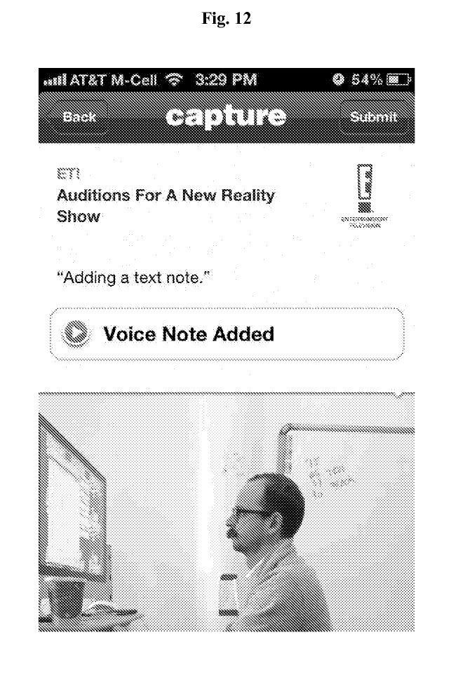

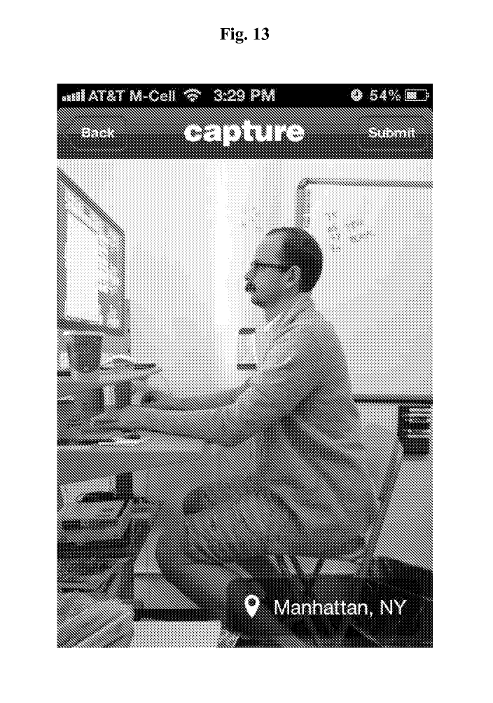

Referring to FIGS. 12 and 13, in a particular embodiment, a software module for allowing a contributor to preview captured media prior to submission provides an interface for previewing captured media that includes contributor comments (e.g., voice comments, text comments, etc.) and the location where the media was captured.

In some embodiments, a contributor application includes software modules for enabling a contributor to manage and organize their captured media and submitted media as well as track and share their captured and submitted media. For example, in some embodiments, a contributor application includes a software module for displaying a gallery of media captured by the contributor. In some embodiments, a contributor application includes a software module for viewing media submitted by other contributors.

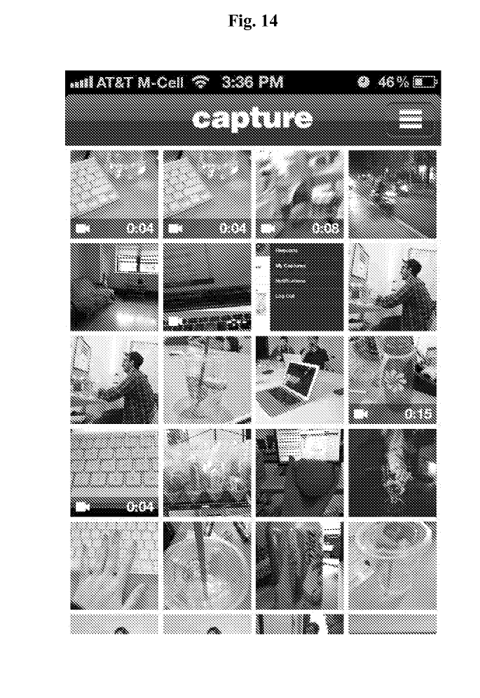

Referring to FIG. 14, in a particular embodiment, a contributor application includes software module for presenting an interface including thumbnail images that represent media captured by a contributor. In this embodiment, video media thumbnails indicate the duration of the video.

In some embodiments, a contributor application includes a software module for receiving updates on the status of media. In some embodiments, a contributor receives updates on media they submitted. In some embodiments, a contributor receives updates on media submitted other contributors. In some embodiments, changes to the status of submitted media are triggered by the actions of the contributor. In further embodiments, changes to the status of media are triggered by submissions and sharing to third party social networks by the contributor. In some embodiments, changes to the status of submitted media are triggered by the actions of enterprise users. In further embodiments, changes to the status of submitted media are triggered by views, additions to favorites, additions by lightboxes, downloads, and exclusive downloads by enterprise users. In some embodiments, changes to the status of submitted media are triggered by the actions of other contributors. In further embodiments, changes to the status of submitted media are triggered by views, additions to favorites, and downloads by other contributors.

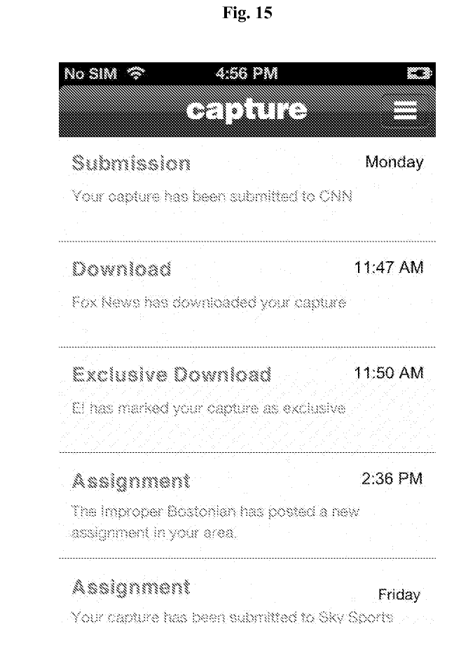

Referring to FIG. 15, in a particular embodiment, a software module for receiving updates on the status of submitted media provides an interface for displaying contributor notifications. In this embodiment, contributor notifications are provided upon submission of media, and views, downloads, and exclusive downloads of submitted media. Further in this embodiment, contributor notifications include receipt of new requests for media (e.g., assignments). Each notification optionally includes a date/time indicator, a title, a description of the event triggering the notification, and an indicator of the party (e.g., media outlet, other contributor, etc.) triggering the event.

In some embodiments, a contributor application includes a software module for generating an alert, notification, or alarm when, for example, a new media request is received, new media is capture or shared by another contributor, the status of media submitted by the contributor changes, and/or the status of media submitted by another contributor changes. In some embodiments, a contributor application includes a software module for generating an alert, notification, or alarm when a direct message is received from an enterprise user. Many forms and formats are suitable for transmission of alerts, notifications, and/or alarms. In various embodiments, suitable formats for alerts, notifications, and/or alarms include, by way of non-limiting examples, intra application notifications, SMS, MMS, email, webmail, blog post, microblog post, social network post, automated phone call, and voicemail.

In some embodiments, a contributor application includes a software module for sharing captured media to one or more social networks. Many social networks are suitable for sharing media including, by way of non-limiting examples, Badoo, Bebo, Blogger, Blogster, Buzzfeed, CafeMom, Classmates.com, Delicious, DeviantART, Digg, Diglo, Facebook, FARK, Flixster, Flickr, Fotolog, Foursquare, Friendfeed, Friends Reunited, Friendster, Google+, Habbo, Linkedln, Livejournal, Meetup, Mixi, Mylife, Myspace, MyYearbook, Netlog, Ning, Pingsta, Pinterest, Plaxo, Reddit, Slashdot, SoundCloud, Stumbleupon, Tagged, Tumblr, Tweetmeme, Twitter, Yammer, Yelp, YouTube, Vimeo, and the like.

In some embodiments, an enterprise application and a contributor application comprise a software module for direct messaging between an enterprise user and one or more contributors. In further embodiments, direct messaging allows a contributor to, for example, respond to requests for additional authentication information for submitted media, receive requests for additional media submissions, and/or participate in discuss regarding the details of submitted media with an enterprise user. Referring to FIG. 16, in a particular embodiment, an interface for direct messaging between a contributor and a media outlet regarding submitted media. See also FIG. 4.

In some embodiments, a contributor application is a standalone application installed by contributors on a computing device such as a desktop or laptop computer. In some embodiments, a contributor application is a web application available on the world wide web and accessible to contributors via a web browser. In other embodiments, a contributor application is a mobile application installed by contributors on a mobile computing device such as a smartphone or tablet computer.

### Server Application

In some embodiments, the systems, platforms, software, networks, and methods described herein include a server application. In further embodiments, a server application coordinates communication between enterprise applications and contributor applications described herein. In still further embodiments, a server application acts as a centralized repository (e.g., database, etc.) of, for example, enterprise users, media requests, contributors, contributor locations, submitted media, and the status indicators associated with users, requests, and media. In some embodiments, a server application transmits media requests authored by enterprise users using an enterprise application and transmits submitted media captured by contributors using a contributor application. In some embodiments, a server application authenticates media upon submission or transmission. In some embodiments, a server application syncs, for example, media requests, media submissions, media status updates, and contributor locations between an enterprise application and one or more contributor mobile applications.

In some embodiments, a server application includes a software module for maintaining a database of contributors. In further embodiments, a database of contributors includes, for example, a profile for each contributor. In still further embodiments, a database of contributors includes a name, age, gender, photograph, preferences, list of skills, list of qualifications, list of previously received media requests, and/or list of previously submitted media for each contributor. In some embodiments, a database of contributors comprises a current geolocation for each contributor. In further embodiments, a current geolocation for each contributor is updated in real time or substantially real time. In further embodiments, a current geolocation for each contributor is updated at least every day, every hour, every minute, every second, or every 900, 800, 700, 600, 500, 400, 300, 200, or 100 milliseconds.

In some embodiments, a server application includes a software module for providing a map of geolocated contributors. In further embodiments, a map of geolocated contributors is optionally adjustable in scale. In still further embodiments, a map of geolocated contributors is displayed within an enterprise application described herein. See, e.g., FIG. 1. In some embodiments, a map of geolocated contributors also includes a location associated with one or more media requests, and optionally, an area define by a radius around each media request location.

In some embodiments, a server application includes software modules for receiving media requests made by enterprise application users and transmitting media requests to appropriate contributor application users. In further embodiments, a media request includes a request geolocation. In still further embodiments, appropriate contributors are identified based on each contributor's current geolocation. By way of non-limiting example, a software module for receiving media requests receives a media request associated with the location 36 W 25^{th} Street, New York, N.Y., 10010 in the United States. The requesting enterprise user has specified a radius of 1.35 miles around that location to define an area. A software module for transmitting media requests to appropriate contributor uses this area and a database of contributors (including current contributor geolocations) to determine that 32 contributors are present in the request area. The software module for transmitting media requests sends the request to these contributors based on geolocation. In some embodiments, appropriate contributors are identified based on information in each contributor's profile including, by way of non-limiting examples, preferences, skills, expertise, experience, age, and the like.

In some embodiments, a server application includes a software module for receiving captured media submitted by users of a contributor application. In some embodiments, a software module for receiving captured media, receives media submitted by contributors in response to a media request. In other embodiments, a software module for receiving captured media, receives media submitted by contributors not in response to any particular media request (e.g., unsolicited media submission). In some embodiments, a software module for receiving captured media performs media authentication.

In some embodiments, a server application includes a software module for authenticating submitted media. In further embodiments, a software module for authenticating submitted media utilizes authentication data associated with submitted media. In still further embodiments, a software module for authenticating submitted media utilizes EXIF data associated with submitted media. In various embodiments, authentication data is associated with submitted media by, for example, a contributor, a media capture device, and/or a contributor application. In some embodiments, a software module for authenticating submitted media authenticates a location, date, time, resolution, and/or creator of the media. In further embodiments, a software module for authenticating submitted media authenticates device settings (e.g., camera, smartphone, handheld computing device, etc.) used to capture the media. In still further embodiments, a software module for authenticating submitted media authenticates copyright information for the media. For example, in a particular embodiment, a software module for authenticating submitted media compares a contributor geolocation to a media capture location, date, and time to authenticate that media was captured at a location specified in a targeted media request.

In some embodiments, a server application includes a software module for transmitting media submitted by contributors to a requesting enterprise user. In further embodiments, a server application includes a software module for providing a gallery for viewing and managing submitted media. In some embodiments, a gallery of submitted media is displayed in a contributor application and is adapted to allow a contributor to view and manage media they have submitted. See, e.g., FIG. 14. In some embodiments, a gallery of submitted media is displayed in an enterprise application and is adapted to allow an enterprise user to view and manage media submitted in response to a media request they have created. See, e.g., FIG. 3.

In some embodiments, a server application includes a software module for syncing media requests and media submissions between one or more enterprise applications and one or more contributor applications. In some embodiments, a server application includes a software module for syncing contributor locations between one or more enterprise applications and one or more contributor applications. In some embodiments, a server application includes a software module for syncing media status updates between one or more enterprise applications and one or more contributor applications. In further embodiments, media status updates include, by way of non-limiting examples, views of media by another user, downloads of media by another user, addition of media to another user's list of favorites, addition of media to another user's media album or lightbox, and selection of media by an enterprise user for publication. In some embodiments, a server application includes a software module for syncing direct messages between one or more enterprise applications and one or more contributor applications. In some embodiments, synching is performed in real time or substantially real time (e.g., synchronous). In other embodiments, synching is performed after some period of delay (e.g., asynchronous).

### Network

In some embodiments, the devices, systems, platforms, and software applications described herein, are in communication and functionally connected to create a targeted media capture network. A targeted media capture network includes any suitable number of enterprise users and enterprise applications. In various embodiments, a targeted media capture network suitably includes, by way of non-limiting examples, 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000 or more enterprise users and enterprise applications, including increments therein.

A targeted media capture network includes any suitable number of contributors and contributor applications. In various embodiments, a targeted media capture network suitably includes, by way of non-limiting examples, 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000 or more contributors and contributor applications, including increments therein. In further various embodiments, a targeted media capture network suitably includes, by way of non-limiting examples, 1000, 2000, 3000, 4000, 5000, 6000, 7000, 8000, 9000, 10000, 20000, 30000, 40000, 50000, 60000, 70000, 80000, 90000, 100000 or more contributors and contributor applications, including increments therein. In still further various embodiments, a targeted media capture network suitably includes, by way of non-limiting examples, 100000, 200000, 300000, 400000, 500000, 600000, 700000, 800000, 900000, 1000000 or more contributors and contributor applications, including increments therein. In light of the disclosure provided herein, those of skill in the art will recognize that high numbers of contributors operating contributor applications and participating in the targeted media capture network extends the reach and effectiveness of the network.

A targeted media capture network includes any suitable number of servers and server applications. In various embodiments, a targeted media capture network suitably includes, by way of non-limiting examples, 1, 2, 3, 4, 5, 6, 7, 8, 9, 10, 11, 12, 13, 14, 15, 16, 17, 18, 19, 20, 30, 40, 50, 60, 70, 80, 90, 100, 200, 300, 400, 500, 600, 700, 800, 900, 1000 or more servers and server applications, including increments therein. In other embodiments, a targeted media capture network suitably includes a server application provided by distributed computing or cloud computing services and/or platforms and, in some cases, utilize a variable number of servers.

In some embodiments, the targeted media capture networks are based on cellular mobile communications systems. In some embodiments, the targeted media capture networks are based on geosynchronous and low Earth orbit (LEO) satellite mobile communications systems. In some embodiments, the targeted media capture networks are intranet-based. In some embodiments, the targeted media capture networks are internet-based. In further embodiments, the targeted media capture networks are world wide web-based. In still further embodiments, the targeted media capture networks are cloud computing-based. In other embodiments, the targeted media capture networks are based on data storage devices including, by way of non-limiting examples, CD-ROMs, DVDs, flash memory devices, magnetic disk drives, magnetic tapes drives, optical disk drives, and cloud computing based storage.

### Methods

In some embodiments, the methods described herein are methods of providing mobile applications, web applications, and/or server applications for targeted media capture. In other embodiments, the methods described herein are methods of providing services, platforms, and networks for targeted media capture. In other embodiments, the methods described herein are methods carried out by software providers and service providers engaged in creating tools for targeted media capture. In yet other embodiments, the methods described herein are methods carried out by media outlets and contributors engaged in targeted media capture.

The inventions disclosed herein include business methods. In some embodiments, the systems, platforms, software, networks, and methods disclosed herein are marketed, advertised, and sold as, for example, products for providing targeted media capture systems and networks. In some embodiments, the software and methods disclosed herein are marketed, advertised, and sold as, for example, targeted media capture applications and software. In further embodiments, the applications and software are marketed, advertised, and sold as mobile applications and/or server applications. In other embodiments, the systems, platforms, software, networks, and methods disclosed herein are marketed, advertised, and sold as, for example, targeted media capture services. In further embodiments, the services are provided as platform as a service (PaaS). In further embodiments, the services are provided as software as a service (SaaS). The applications, platforms, networks and services disclosed herein are particularly well suited for extending the reach of news and media organizations by tapping into the hundreds of millions of smartphones carried by individuals worldwide. The products and services disclosed herein are also well suited for accelerating the speed with which news and media organizations acquire media from the field. Moreover, the products and services disclosed herein create transparency for contributors and encourage participation in media capture.

### Digital Processing Device

In some embodiments, the systems, platforms, software, networks, and methods described herein include a digital processing device, or use of the same. In further embodiments, the digital processing device includes one or more hardware central processing units (CPUs), i.e., processors that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, a digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX °, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, a digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, a digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, a digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, a digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, and higher megapixel cameras, including increments therein. In some embodiments, a digital camera is a standard definition camera. In other embodiments, a digital camera is an HD video camera. In further embodiments, an HD video camera captures images with at least about 1280× about 720 pixels or at least about 1920× about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

### Non-Transitory Computer Readable Storage Medium

In some embodiments, the systems, platforms, software, networks, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, platforms, software, networks, and methods disclosed herein include at least one computer program. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, platforms, software, networks, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### EXAMPLES

The following illustrative examples are representative of embodiments of the software applications, systems, and methods described herein and are not meant to be limiting in any way.

### Example 1

### Making a Targeted Media Request

A New York-based print media and online magazine publisher is interested in providing her readers a review of a music festival. The music festival is starting the evening of the current day in Atlanta, Ga. She does not have the time or resources to travel to the festival or send a representative to observe the festival. She uses an enterprise application described herein that is installed on her Apple® iPad® to create a targeted media request. She taps the location of the festival on an interactive map and types a description of her request, which includes a request for photos, video, and a text review of the headlining performer (limited to 300 words). She targets her media request by specifying a 30 mile radius around the location and specifying that she would like media submissions from contributors who have either submitted similar media in the past or have expressed in interest in music.

### Example 2

### Transmitting a Targeted Media Request

Her enterprise application transmits her request to a server application, which identifies appropriate contributors to receive her targeted request. The server application identifies 18 appropriate contributors based on the current location, prior media submissions, and profile of each. The server then sends the request to the identified 18 contributors who each receive an audible alert and notification at their mobile smartphones via a contributor mobile application described herein.

### Example 3

### Capturing and Submitting Targeted Media

Five of the targeted contributors are already planning to attend the music festival and decide to capture media in response to the request. At the festival that evening, each of the 5 contributors captures dozens of high resolution photos and videos with Apple® iPhones®. Each also subsequently writes a 300 (or less) word review of the headlining band's performance. They each submit their captured media over the next 24 hours via their contributor mobile applications.

### Example 4

### Tracking Submitted Media

All of the contributors monitor the status of their submitted media via their contributor applications. Two of the contributors are pleased to see that the publisher downloaded their submitted media in full resolution the next day. The publisher reviews the downloaded media, which has been authenticated by the targeted media capture network with regard to author, location, date, and time, and is particularly interested in one set of media submitted. She directly messages the contributor, via the targeted media capture network, to ask about his further impressions of the festival and let him know that she would like to use his media in the next issue of her magazine.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A targeted media capture platform comprising:
a. a processor configured to provide an enterprise application comprising: a software module for sending media requests, each media request made by an enterprise user associated with a publishing outlet and comprising a subject matter description, a request location, an area about the location, and a date or time window, wherein the media requests are targeted to contributors based on the subject matter, the location, the area about the location, and the date or time window; a software module for receiving and managing media submitted by contributors;
b. a mobile processor configured to provide a contributor mobile application comprising: a software module for receiving media requests, wherein the media requests are filtered based on the subject matter description, the request location, the area about the location, and the date or time window in relation to an individual contributor profile and contributor location, the contributor profile comprising subject matter expertise or preference; a software module for annotating captured media, wherein the annotations comprise one or more of: contributor text or voice annotations; a software module for submitting media in response to media requests; a software module for providing transparency to the contributors by allowing each contributor to monitor the status of media submitted by the contributor, the monitoring the status comprising providing visibility of one or more of the following actions by an enterprise user: view, download, addition to favorite, addition to album, addition to lightbox, and publication, wherein the enterprise user taking the action and the associated publishing outlet is identified;
c. a server comprising a processor configured to provide a server application comprising: a software module for syncing media requests, media submissions, media status updates, and contributor locations between an enterprise application and one or more contributor mobile applications; and a software module for authenticating submitted media.

2. The platform of claim 1, wherein media comprise text, audio recordings, photographs, videos, or combinations of the same.

3. The platform of claim 1, wherein the enterprise application further comprises a software module for providing a map of geolocated contributors.

4. (canceled)

5. The platform of claim 1, wherein the enterprise application further comprises a software module for providing a gallery to view and manage submitted media.

6. The platform of claim 1, wherein the enterprise application further comprises a software module for direct messaging with one or more contributors.

7. The platform of claim 1, wherein the enterprise application is a mobile application.

8. The platform of claim 1, wherein the contributor mobile application further comprises a software module for viewing media submitted by others.

9. The platform of claim 1, wherein the contributor mobile application allows unrequested media submissions.

10. The platform of claim 1, wherein the server application authenticates media by one or more selected from: location, date, time, resolution, and creator.

11. (canceled)

12. Non-transitory computer-readable storage media encoded with a computer program including instructions executable by a processor to create a targeted media capture server application comprising:
a. a software module for maintaining a database of contributors, wherein the database comprises a current geolocation for each contributor;
b. a software module for receiving media requests made by enterprise users, each enterprise user associated with a publishing outlet, wherein each media request comprises a subject matter description, a request location, an area about the location, and a date or time window;
c. a software module for transmitting media requests to appropriate contributors based on a subject matter description, a request location, an area about the location, and a date or time window in relation to a profile and a location for each contributor, the profile comprising subject matter expertise or preference;
d. a software module for receiving media submitted by contributors in response to a media request, wherein each submitted media comprises authentication data and one or more contributor text or voice annotations;
e. a software module for authenticating submitted media;
f. a software module for transmitting media submitted by contributors to a requesting enterprise user; and
g. a software module for providing transparency to the contributors by allowing each contributor to monitor the status of media submitted by the contributor, the monitoring the status comprising providing visibility of one or more of the following actions by an enterprise user: view, download, addition to favorite, addition to album, addition to lightbox, and publication, wherein the enterprise user taking the action and the associated publishing outlet is identified.

13. The storage media of claim 12, wherein submitted media comprise text, audio recordings, photographs, videos, or combinations of the same.

14. The storage media of claim 12, wherein the server application further comprises a software module for providing a map of geolocated contributors.

15. The storage media of claim 12, wherein the server application further comprises a software module for providing a gallery to view and manage submitted media.

16. The storage media of claim 12, wherein the server application further comprises a software module for direct messaging between an enterprise user and one or more contributors.

17. The storage media of claim 12, wherein the software module for receiving media submitted by contributors allows unrequested media submissions.

18. The storage media of claim 12, wherein the software module for authenticating submitted media authenticates media by one or more selected from: location, date, time, resolution, and creator.

19. (canceled)

20. (canceled)

21. (canceled)

22. (canceled)

23. A computer-based targeted media capture network comprising a server processor configured at least to:
a. maintain a database of a plurality of contributors, wherein each contributor is associated with a current location;
b. provide substantially synchronous communications between one or more enterprise users and the plurality of contributors, each enterprise user associated with a publishing outlet, wherein the communications comprise:
i. media requests by the one or more enterprise users, each media request comprising a subject matter description, a request location, an area about the location, and a date or time window, each media request targeted to contributors based on the subject matter description, the request location, the area about the location, and the date or time window in relation to a profile and a location for each contributor, each profile comprising subject matter expertise or preference;
ii. media submissions by the plurality of contributors in response to the media requests,
iii. contributor text or voice annotations associated with submitted media;
iv. updates on the status of media submitted by each contributor, the updates comprising providing visibility of one or more of the following actions by an enterprise user: view, download, addition to favorite, addition to album, addition to lightbox, and publication, the updates providing transparency to the contributors, wherein the enterprise user taking the action and the associated publishing outlet is identified; and
c. authenticate submitted media based on the request location, the area about the location, and the date or time window in relation to an individual contributor location.

24. The network of claim 23, wherein media comprise text, audio recordings, photographs, videos, or combinations of the same.

25. The network of claim 23, wherein the server processor is further configured to provide a map of geolocated contributors.

26. The network of claim 23, wherein the server processor is further configured to provide a gallery to view and manage submitted media.

27. The network of claim 23, wherein the server processor is further configured to provide direct messaging between the one or more enterprise users and the plurality of contributors.

28. The network of claim 23, wherein the one or more enterprise users interact with the network via an enterprise application.

29. The network of claim 23, wherein the plurality of contributors interact with the network via a contributor mobile application.

30. (canceled)

31. The platform of claim 1, wherein the software module for providing transparency to the contributors by allowing each contributor to monitor the status of media submitted specifies whether publication is to a traditional, social, or digital medium.

32. The platform of claim 1, wherein the software module for providing transparency to the contributors allows each contributor to monitor the status of media submitted by other contributors.

33. The media of claim 12, wherein the software module for providing transparency to the contributors by allowing each contributor to monitor the status of media submitted specifies whether publication is to a traditional, social, or digital medium.

34. The media of claim 12, wherein the software module for providing transparency to the contributors allows each contributor to monitor the status of media submitted by other contributors.

35. The network of claim 23, wherein the updates on the status of media submitted by each contributor specify whether publication is to a traditional, social, or digital medium.

36. The network of claim 23, wherein the software module for providing transparency to the contributors allows each contributor to monitor the status of media submitted by other contributors.
